(19) United States
(12) Patent Application Publication
(10) Pub. No.: US 2026/0340356 A1
(43) Pub. Date: Oct. 29, 2026

(54) GENERATING ACTION MODELS USING GENERATIVE ARTIFICIAL INTELLIGENCE

(71) Applicant: Dell Products L.P., Round Rock, TX (US)

(72) Inventors: Bijan Kumar Mohanty, Austin, TX (US); Javedh Jafferi Shaik, Rajahmundry (IN); PSVV Rama Raju, Miyapur (IN); David West, Noblesville, IN (US); Hung T. Dinh, Austin, TX (US)

(21) Appl. No.: 19/189,829

(22) Filed: Apr. 25, 2025

(51) Int. Cl. G06N 3/0475; G06N 3/0442

(52) U.S. Cl. CPC G06N 3/0475; G06N 3/0442

(57) ABSTRACT

Methods, apparatus, and processor-readable storage media for generating action models using generative artificial intelligence are provided herein. An example computer-implemented method includes obtaining conversation data from one or more communication channels; identifying one or more action items, related to at least one designated context, within the conversation data by processing at least a portion of the conversation data using a first set of artificial intelligence techniques; determining at least one backend system plugin to be used in connection with executing at least one of the action items using a second set of artificial intelligence techniques; generating at least one payload for the backend system plugin(s) by processing, using generative artificial intelligence, data pertaining to the at least one action item and the backend system plugin(s); and automatically executing, via at least one backend system corresponding to the backend system plugin(s), the at least one action item using the generated payload(s).

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

In many contexts, natural language conversations occur continuously across multiple channels (e.g., meetings, emails, chat platforms, phone calls, etc.) in connection with a variety of functions and/or operations. These exchanges often contain actionable insights and tasks that require execution but are commonly scattered across different communication streams. However, conventional communication data processing approaches fail to capture such multi-stream communication insights, and include resource-intensive and error-prone techniques which can result in latencies and under-inclusive outcomes.

### SUMMARY

Illustrative embodiments of the disclosure provide techniques for generating action models using generative artificial intelligence.

An example computer-implemented method includes obtaining conversation data from one or more communication channels, and identifying one or more action items, related to at least one designated context, within the conversation data by processing at least a portion of the conversation data using a first set of one or more artificial intelligence techniques. The method also includes determining at least one backend system plugin to be used in connection with executing at least one of the one or more action items using a second set of one or more artificial intelligence techniques. Further, the method additionally includes generating at least one payload for the at least one backend system plugin by processing, using generative artificial intelligence techniques, data pertaining to the at least one action item and data pertaining to the at least one backend system plugin, and automatically executing, via at least one backend system corresponding to the at least one backend system plugin, the at least one action item using the at least one generated payload.

Illustrative embodiments can provide significant advantages relative to conventional communication data processing approaches. For example, problems associated with latencies and under-inclusive outcomes arising from resource-intensive and error-prone techniques are overcome in one or more embodiments through automatically extracting action items from conversation data and executing the action items through determined backend system plugins.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for generating action models using generative artificial intelligence in an illustrative embodiment.

FIG. 2 shows an example workflow in an illustrative embodiment.

FIG. 3 shows example system architecture in an illustrative embodiment.

FIG. 4 shows example pseudocode for importing necessary elements in an illustrative embodiment.

FIG. 5 shows example pseudocode for implementing at least one training data frame in an illustrative embodiment.

FIG. 6 shows example pseudocode for transforming conversation data to numerical data in an illustrative embodiment.

FIG. 7 shows example pseudocode for encoding action item labels in an illustrative embodiment.

FIG. 8 shows example pseudocode for splitting data into training and testing sets in an illustrative embodiment.

FIG. 9 shows example pseudocode for configuring a neural network model for multi-label classification in an illustrative embodiment.

FIG. 10 shows example pseudocode for compiling and training the neural network model in an illustrative embodiment.

FIG. 11 shows example pseudocode for evaluating the neural network model in an illustrative embodiment.

FIG. 12 shows example pseudocode for generating predictions on input conversation data in an illustrative embodiment.

FIG. 13 shows example plugin prediction engine architecture in an illustrative embodiment.

FIG. 14 shows example pseudocode for importing necessary libraries and reading metadata into a data frame in an illustrative embodiment.

FIG. 15 shows example pseudocode for converting categorical data into numerical data in an illustrative embodiment.

FIG. 16 shows example pseudocode for splitting feature data and target data in an illustrative embodiment.

FIG. 17 shows example pseudocode for scaling feature data in an illustrative embodiment.

FIG. 18 shows example pseudocode for configuring a neural network model for predicting plugins in an illustrative embodiment.

FIG. 19 shows example pseudocode for compiling and training the neural network model in an illustrative embodiment.

FIG. 20 shows example pseudocode for evaluating the neural network model in an illustrative embodiment.

FIG. 21 shows example pseudocode for encoding input data for use in predicting a plugin in an illustrative embodiment.

FIG. 22 shows example pseudocode for populating a payload template in an illustrative embodiment.

FIG. 23 shows example pseudocode for authenticating to a backend system in an illustrative embodiment.

FIG. 24 shows example pseudocode for calling a function on the backend system in an illustrative embodiment.

FIG. 25 shows example pseudocode for dynamically generating a payload in an illustrative embodiment.

FIG. 26 is a flow diagram of a process for generating action models using generative artificial intelligence in an illustrative embodiment.

FIGS. 27 and 28 show examples of processing platforms that may be utilized to implement at least a portion of an information processing system in illustrative embodiments.

### DETAILED DESCRIPTION

Illustrative embodiments will be described herein with reference to example computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

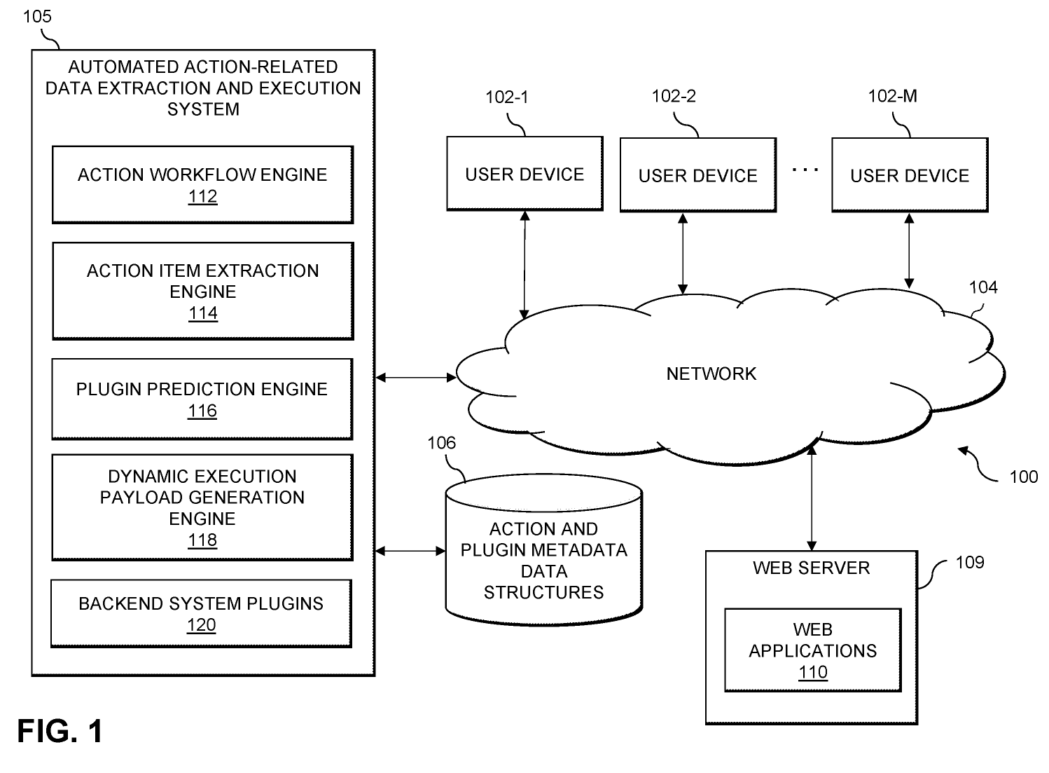

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is automated action-related data extraction and execution system 105 and web server 109, upon which one or more web applications 110 (e.g., one or more telecommunications application, one or more web chat applications, one or more email client applications, one or more technology support applications, etc.) execute.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the automated action-related data extraction and execution system 105 can have one or more action and plugin metadata data structures 106 configured to store data pertaining to multiple backend system plugins as well as multiple system-related actions. The term “data structure,” as used herein, is intended to be broadly construed, so as to encompass, for example, a wide variety of different types of tables, arrays, graphs, trees, linked lists, and additional or alternative data relation mechanisms, as well as portions or combinations thereof. Accordingly, a given data structure can comprise a combination of multiple smaller data structures, possibly of different types, or a portion of a larger data structure. Numerous other arrangements are possible.

The action and plugin metadata data structures 106 in the present embodiment are implemented using one or more storage systems associated with the automated action-related data extraction and execution system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the automated action-related data extraction and execution system 105 are one or more input-output devices, which illustratively comprise keyboards, displays or other types of input-output devices in any combination. Such input-output devices can be used, for example, to support one or more user interfaces to the automated action-related data extraction and execution system 105, as well as to support communication between the automated action-related data extraction and execution system 105 and other related systems and devices not explicitly shown.

Additionally, the automated action-related data extraction and execution system 105 in the FIG. 1 embodiment is assumed to be implemented using at least one processing device. Each such processing device generally comprises at least one processor and an associated memory, and implements one or more functional modules for controlling certain features of the automated action-related data extraction and execution system 105.

More particularly, the automated action-related data extraction and execution system 105 in this embodiment can comprise a processor coupled to a memory and a network interface.

The processor may comprise, for example, a microprocessor, an application-specific integrated circuit (ASIC), a system-on-chip (SOC), a field-programmable gate array (FPGA), a central processing unit (CPU), a graphics processing unit (GPU), a neural processing unit (NPU), a data processing unit (DPU), a tensor processing unit (TPU), an arithmetic logic unit (ALU), a digital signal processor (DSP), and/or other similar processing device components, as well as other types and arrangements of processing circuitry, in any combination. At least a portion of the functionality of at least one artificial intelligence system and its associated artificial intelligence algorithms provided by one or more processing devices as disclosed herein can be implemented using such circuitry.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the automated action-related data extraction and execution system 105 to communicate over the network 104 with the user devices 102, and illustratively comprises one or more conventional transceivers.

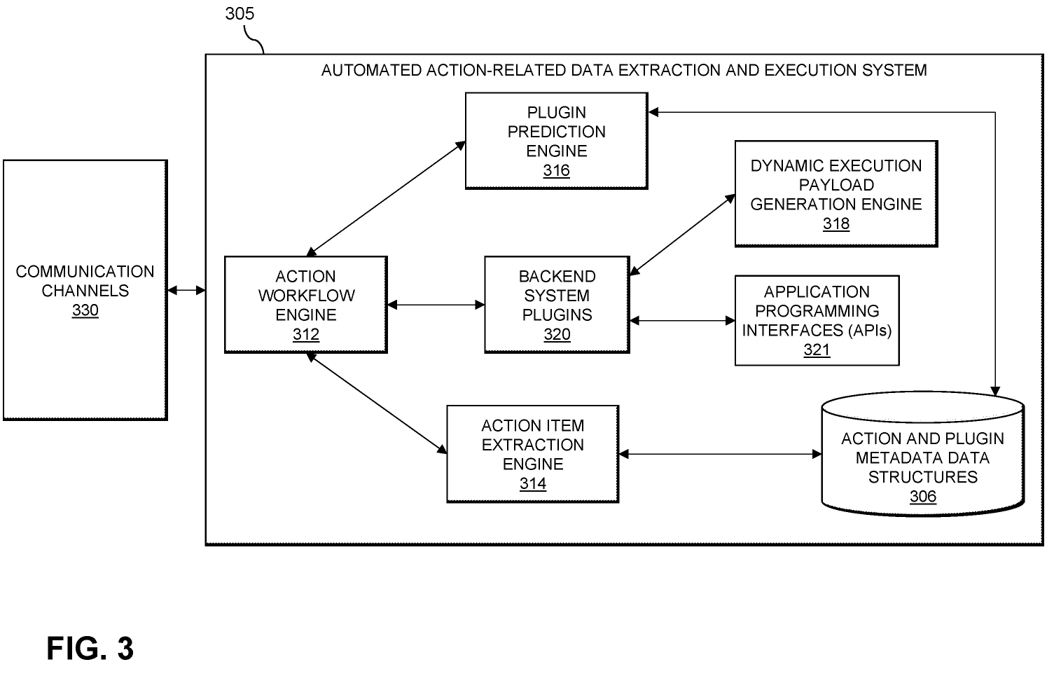

The automated action-related data extraction and execution system 105 further comprises action workflow engine 112, action item extraction engine 114, plugin prediction engine 116, dynamic execution payload generation engine 118, and backend system plugins 120, such as further described, for example, in connection with FIG. 3 below.

It is to be appreciated that this particular arrangement of elements 112, 114, 116, 118 and 120 illustrated in the automated action-related data extraction and execution system 105 of the FIG. 1 embodiment is presented by way of example only, and alternative arrangements can be used in other embodiments. For example, the functionality associated with elements 112, 114, 116, 118 and 120 in other embodiments can be combined into a single module, or separated across a larger number of modules. As another example, multiple distinct processors can be used to implement different ones of elements 112, 114, 116, 118 and 120 or portions thereof.

At least portions of elements 112, 114, 116, 118 and 120 may be implemented at least in part in the form of software that is stored in memory and executed by a processor.

It is to be understood that the particular set of elements shown in FIG. 1 for generating action models using generative artificial intelligence involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of automated action-related data extraction and execution system 105, action and plugin metadata data structures 106, and web server 109 can be on and/or part of the same processing platform.

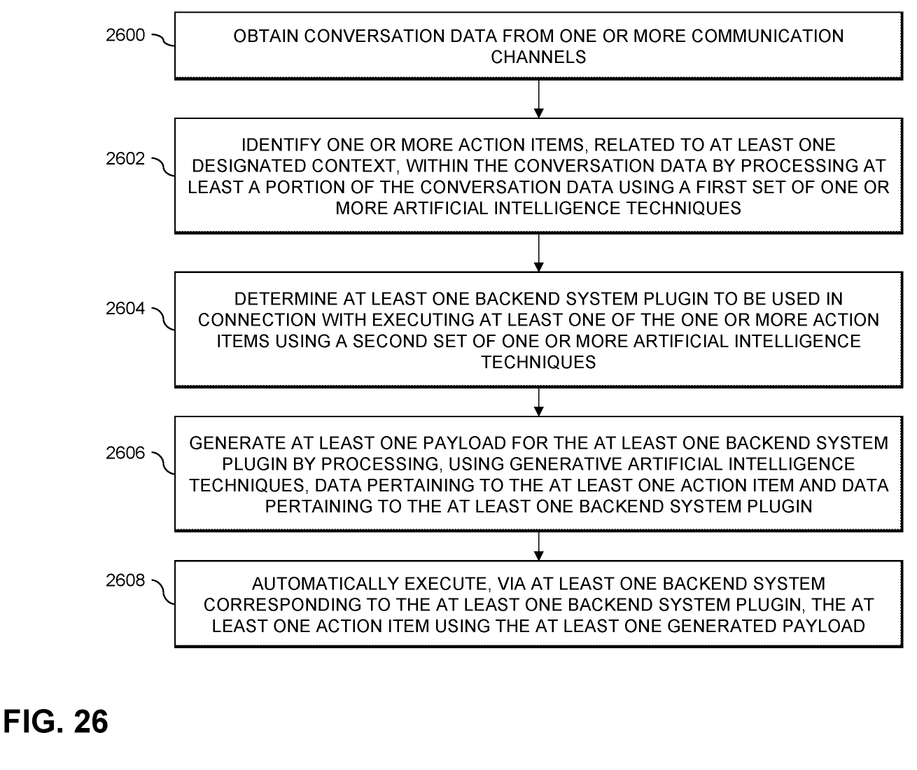

An example process utilizing elements 112, 114, 116, 118 and 120 of an example automated action-related data extraction and execution system 105 in computer network 100 will be described in more detail with reference to the flow diagram of FIG. 26.

Accordingly, at least one embodiment includes generating action models using generative artificial intelligence. As further detailed herein, such an embodiment includes generating and/or implementing an end-to-end framework that extracts actionable items from natural language conversations across various channels (e.g., emails, meetings, calls, chats, etc.) and initiates automated actions related thereto, enabling full automation within one or more workflows.

One or more embodiments include implementing dynamic, context-aware routing using at least one deep neural network classifier, which enables context-based routing, dynamically selecting the appropriate plugin(s) for each action based at least in part on the content source and the recipient system’s needs. Also, as further detailed herein, at least one embodiment includes leveraging use case-specific natural language processing (NLP) techniques and at least one neural network-based multi-label classification model, trained via supervised learning (e.g., using labeled data specific to the enterprise and/or user in question), which enables accurate extraction of relevant action items from various communication channel data.

Further, one or more embodiments include implementing dynamic plugin assignment techniques using contextual intelligence. In such an embodiment, at least one deep neural network multi-class classifier is utilized to consider both action and context, dynamically selecting the most suitable plugin(s) for the given use case. For instance, a case creation action may route to a customer relationship management (CRM) plugin if it is customer-facing, but may route to an enterprise workflow management plugin for internal employee cases, enhancing adaptability. Additionally, at least one embodiment can include facilitating backend plugin flexibility by leveraging a plugin system that supports both static template-based payload generation and generative artificial intelligence-driven template-based payload generation. Such an approach enhances flexibility and adaptability, enabling seamless integration with diverse backend systems while allowing enterprises and/or users to select between static and dynamic integration methods.

Accordingly, as further detailed herein, one or more embodiments include automatically converting communication data derived from meetings, email communications, shared documents, etc., into actionable tasks and routing data pertaining to the actionable tasks to one or more task-specific systems for execution.

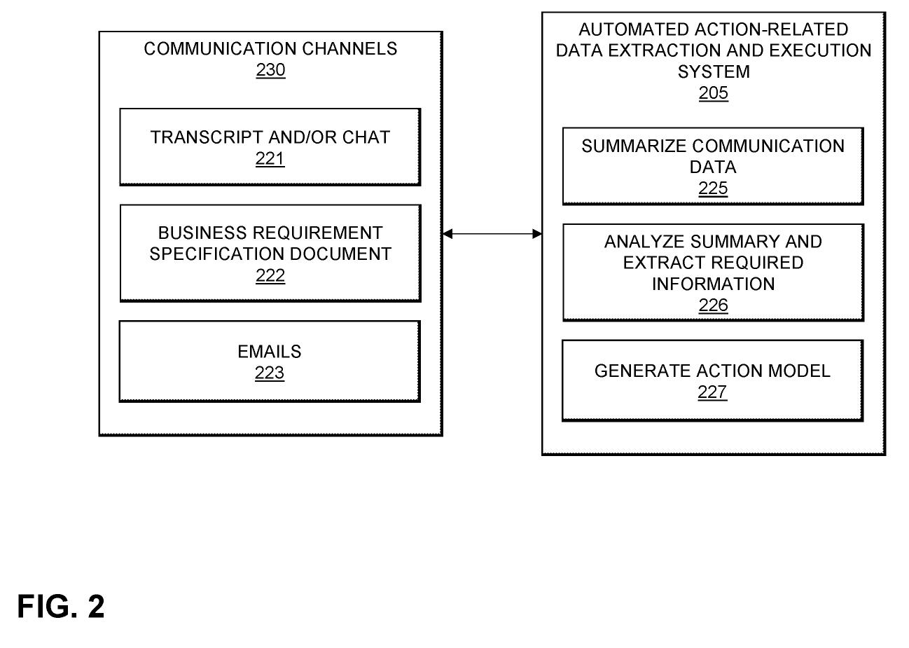

FIG. 2 shows an example workflow in an illustrative embodiment. By way of illustration, FIG. 2 depicts processing communication data from multiple communication channels 230, including a transcript and/or chat 221 from a telecommunication meeting, a business requirement specification document 222, and emails 223 pertaining to one or more issues. Such processing can be performed by automated action-related data extraction and execution system 205 which can include summarizing at least a portion of the communication data in step 225 using one or more generative artificial intelligence models (e.g., one or more generative pretrained transformers (GPTs), one or more pretrained and instruction-fine-tuned language models, etc.). Additionally, at least one embodiment can include, in step 226, analyzing the generated summary and extracting required information (e.g., identifying one or more action items, and categorizing the one or more action items based on action item type). Further, step 227 includes generating an action model for each of the one or more action item based on its corresponding type. For example, if an issue is identified and discussed in the meeting, and a developer has agreed to remedy the issue, then an example embodiment can include creating an email with the required task-relevant information for the automatic creation of an incident in an enterprise workflow management system.

Accordingly, at least one embodiment includes generating an action model by extracting actions and/or language describing actions from a set of communication data (e.g., a meeting transcript), generating instructions based on the actions, and automating the execution of the actions using the instructions in conjunction with one or more systems. Also, the actions that are extracted from a set of communication data can be, for example, domain specific, based at least in part on the participants involved in the corresponding communication.

As noted, one or more embodiments include generating and/or implementing an intelligent, pluggable framework that receives natural language conversation data across various channels and, using one or more NLP techniques (e.g., at least one term frequency-inverse document frequency vectorizer (TfIDFVectorizer)) and one or more multi-label classification techniques (e.g., at least one long short-term memory (LSTM) neural network), identifies one or more action items within the conversation data and leverages one or more smart plugins for one or more backend systems to automatically execute the one or more action items. In such an embodiment, smart plugins can be added to or removed from the framework as per the need of the enterprise and/or user. As further detailed herein, a smart plugin framework can be implemented to identify which plugin is needed for what action item. For example, there may be just one action item (e.g., creating a support ticket) while there may be two available plugins. Based at least in part on the context and identifying information of the communication participants, the more appropriate of the two plugins can be selected and/or predicted by the smart plugin framework.

Additionally, in one or more embodiments, a particular smart plugin is predicted and/or selected for use by leveraging machine learning-based classification of the action item in question as well as context-based data related to the action item in question. Further, such plugins can use a hybrid approach, which can include using templates for standard payloads and utilize generative artificial intelligence with retrieval augmented generation (RAG) to generate complex payloads, for execution of the corresponding action items (e.g., by calling the appropriate application programming interface (API) to execute the given action item). As detailed herein, a job of the plugins includes implementing specific tasks (for example, sending an email, creating a ticket in a given system, etc.). In one or more embodiments, plugins can use at least one API to the appropriate back-end system(s) to achieve implementation of the given task(s). These APIs will need a specific payload to function, and the payload formats will vary from system to system and/or API to API.

FIG. 3 shows example system architecture in an illustrative embodiment. By way of illustration, FIG. 3 depicts implementation of automated action-related data extraction and execution system 305, which is capable of extracting specific action items from natural language conversation data, predicting the most appropriate smart plugin(s) for execution of the action items, and seamlessly integrating with one or more backend systems to automatically perform and/or complete the action items.

More particularly, natural language conversations from various communication channels 330 are received and processed by action workflow engine 312, which can include at least one workflow orchestration tool. The action workflow engine 312 passes the content to action item extraction engine 314, which is trained on data from action and plugin metadata data structures 306 to predict and/or determine one or more action items in the content that are relevant and/or specific to the user and/or enterprise in question. Once an action item is identified, along with relevant context data, the action item details are passed (via action workflow engine 312) to plugin prediction engine 316, which is trained on data from action and plugin metadata data structures 306 to predict which backend system plugin is appropriate for executing the action item. In a scenario wherein multiple actions are identified, multiple backend system plugins can be predicted and selected for use. Once a plugin is identified, the action workflow engine 312 will send metadata of the content to the given backend system plugin, from among the collection of backend system plugins 320, for execution. Also, the selected plugin can use the appropriate API, from among a set of APIs 321, to the corresponding backend system for the automated execution of the action item. Further, as APIs require the generation of a proper payload, the selected plugin can use a hybrid approach of for payload generation. In case of a simple payload (e.g., static data elements), a template-driven approach can be used, while in the case of a more complex and/or dynamic payload format, the selected plugin can use dynamic execution payload generation engine 318 to generate the payload and pass the payload to the given API.

As detailed herein, an action workflow engine can include a façade and workflow component that receives conversational content in natural language form, and uses an orchestration to manage the end-to-end execution lifecycle of the conversation. More particularly, the action workflow engine can extract one or more action items from the content using one or more NLP techniques in connection with a classification-based action item extraction engine. A plugin prediction engine is then called to determine and/or predict one or more appropriate smart plugins for use in automatically executing the one or more action items. As noted, in the case of multiple actions items being identified in conversational data, multiple plugins can be predicted and called for execution of the action items in parallel for enhanced efficiency.

In one or more embodiments, the action item extraction engine can leverage at least one term frequency-inverse document frequency (TF-IDF) vectorizer in conjunction with at least one LSTM network model to predict action items from natural language conversation data. In such an embodiment, a TF-IDF vectorizer transforms unstructured conversational data into numerical features, which an LSTM network model uses to identify one or more potential action items. This multi-label classification approach facilitates recognizing various actionable intents from a single conversation, even if the actionable intents appear in complex sentence structures and/or sequences.

More particularly, in at least one embodiment, the TF-IDF vectorizer converts text data into one or more meaningful numerical features (also referred to herein as vectors) by assigning a weight to each word, based on the word’s frequency in the text and the overall corpus (e.g., the language corpus). This transformation allows the neural network (e.g., the LSTM network model) to focus on relevant terms when predicting one or more action items. As a result, the numerical features output by the TF-IDF vectorizer can capture the semantic meaning of the conversation data in a compact, structured vector form that can be readily processed by the LSTM network model.

As such, the LSTM network model, which can be designed and/or trained to process sequential data by capturing dependencies and patterns across sequences of words, is implemented to predict text-based action items. In at least one embodiment, the LSTM network model takes the numerical vectors generated by the TF-IDF vectorizer as input, maintaining a memory of previous words and how those words relate to each other. This memory enables the LSTM network model to learn and/or understand contextual relationships (for example, distinguishing between a “create case” request from an internal team versus a customer). The multi-label output layer in the LSTM network model allows the LSTM network model to predict multiple action items simultaneously, if the conversation data contains multiple tasks or intents. This architecture ensures that even subtle or implicit action items can be accurately detected based at least in part on their context in the conversation data.

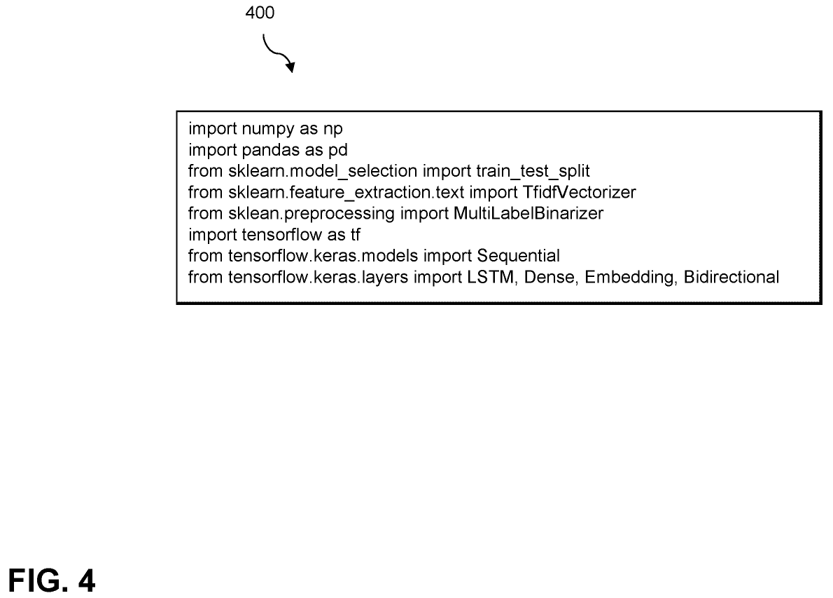

The implementation of the action item extraction engine can be achieved at least in part, for example, as illustrated in the pseudocode depicted in FIGS. 4-12, using Keras with a Tensorflow backend, Python language, as well as Pandas, Numpy and ScikitLearn libraries.

FIG. 4 shows example pseudocode for importing necessary elements in an illustrative embodiment. In this embodiment, example pseudocode 400 is executed by or under the control of at least one processing system and/or device. For example, the example pseudocode 400 may be viewed as comprising a portion of a software implementation of at least part of automated action-related data extraction and execution system 105 of the FIG. 1 embodiment.

The example pseudocode 400 illustrates importing necessary libraries as well as importing necessary functions and/or models.

It is to be appreciated that this particular example pseudocode shows just one example implementation of importing necessary elements, and alternative implementations can be used in other embodiments.

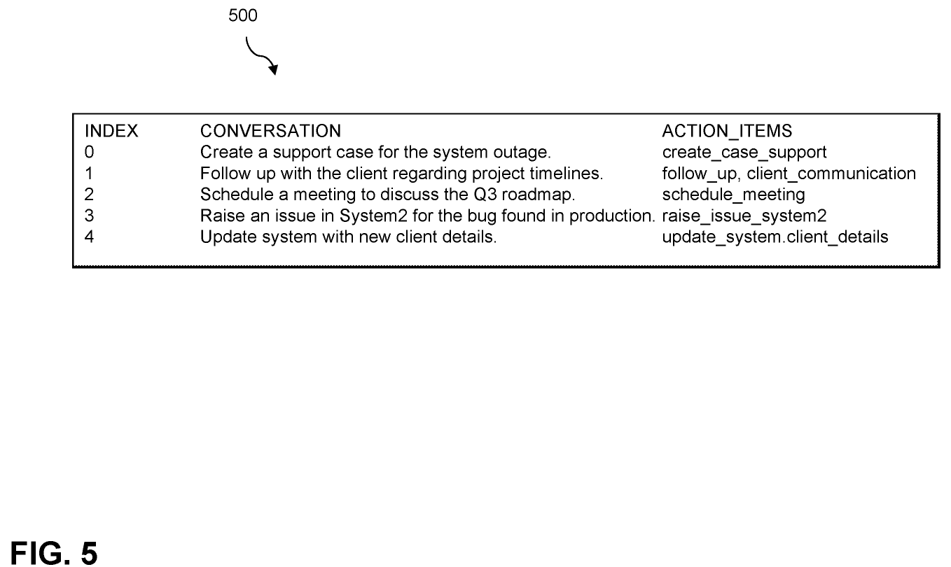

FIG. 5 shows example pseudocode for implementing at least one training data frame in an illustrative embodiment. In this embodiment, example pseudocode 500 is executed by or under the control of at least one processing system and/or device. For example, the example pseudocode 500 may be viewed as comprising a portion of a software implementation of at least part of automated action-related data extraction and execution system 105 of the FIG. 1 embodiment.

The example pseudocode 500 illustrates training data read and implemented as a data frame which contains conversational sentences and one or more typical and/or designated action items.

It is to be appreciated that this particular example pseudocode shows just one example implementation of at least one training data frame, and alternative implementations can be used in other embodiments.

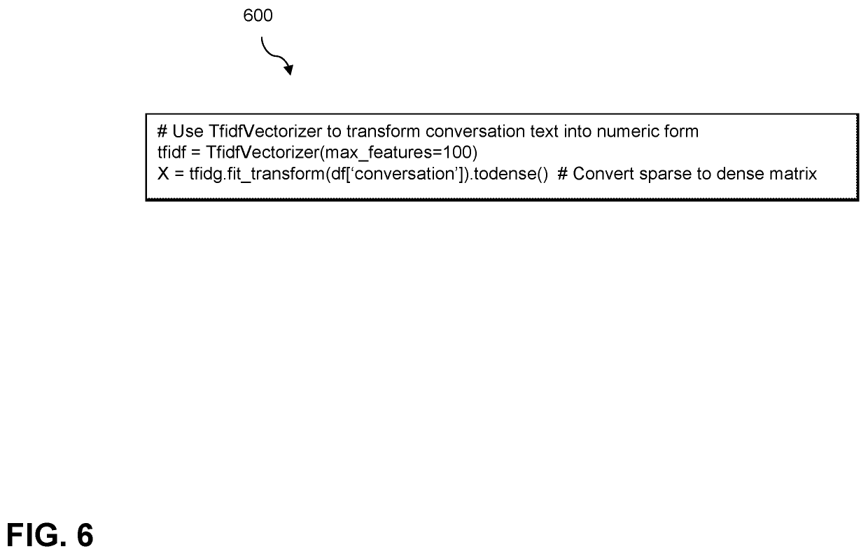

FIG. 6 shows example pseudocode for transforming conversation data to numerical data in an illustrative embodiment. In this embodiment, example pseudocode 600 is executed by or under the control of at least one processing system and/or device. For example, the example pseudocode 600 may be viewed as comprising a portion of a software implementation of at least part of automated action-related data extraction and execution system 105 of the FIG. 1 embodiment.

The example pseudocode 600 illustrates using a TfIDFVectorizer to transform conversation data to numerical data, as machine learning models deal with numerical values.

It is to be appreciated that this particular example pseudocode shows just one example implementation of transforming conversation data to numerical data, and alternative implementations can be used in other embodiments.

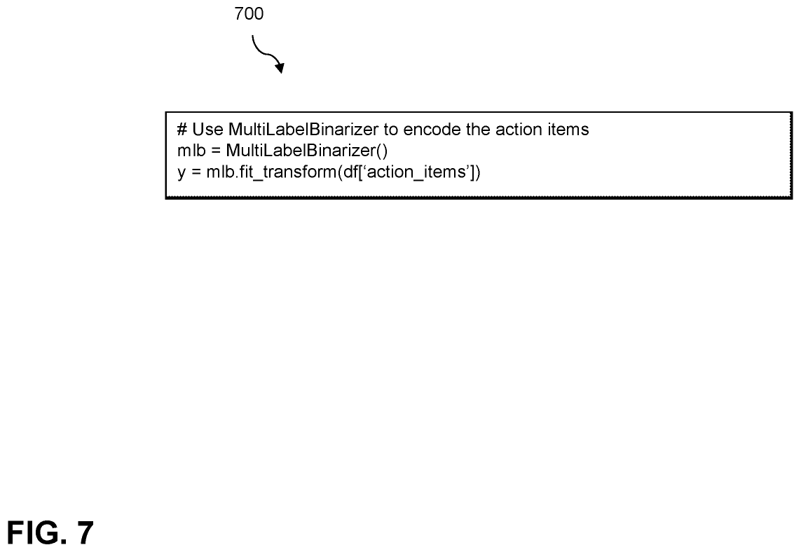

FIG. 7 shows example pseudocode for encoding action item labels in an illustrative embodiment. In this embodiment, example pseudocode 700 is executed by or under the control of at least one processing system and/or device. For example, the example pseudocode 700 may be viewed as comprising a portion of a software implementation of at least part of automated action-related data extraction and execution system 105 of the FIG. 1 embodiment.

The example pseudocode 700 illustrates using a multi-label binarizer to encode multiple action item labels into a binary format for each of multiple conversation data portions, in furtherance of building a multi-label classifier to predict action items.

It is to be appreciated that this particular example pseudocode shows just one example implementation of encoding action item labels, and alternative implementations can be used in other embodiments.

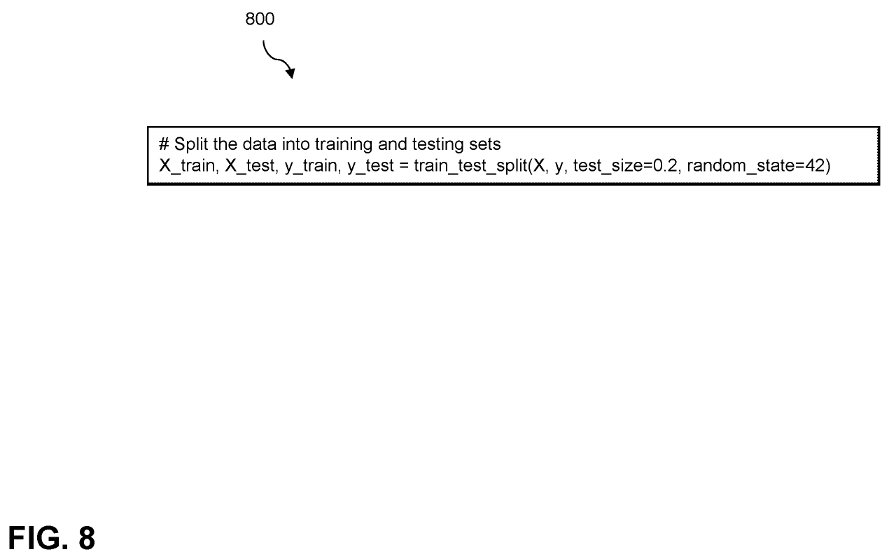

FIG. 8 shows example pseudocode for splitting data into training and testing sets in an illustrative embodiment. In this embodiment, example pseudocode 800 is executed by or under the control of at least one processing system and/or device. For example, the example pseudocode 800 may be viewed as comprising a portion of a software implementation of at least part of automated action-related data extraction and execution system 105 of the FIG. 1 embodiment.

The example pseudocode 800 illustrates preparing for implementing training data by splitting preprocessed data into training and testing sets.

It is to be appreciated that this particular example pseudocode shows just one example implementation of splitting data into training and testing sets, and alternative implementations can be used in other embodiments.

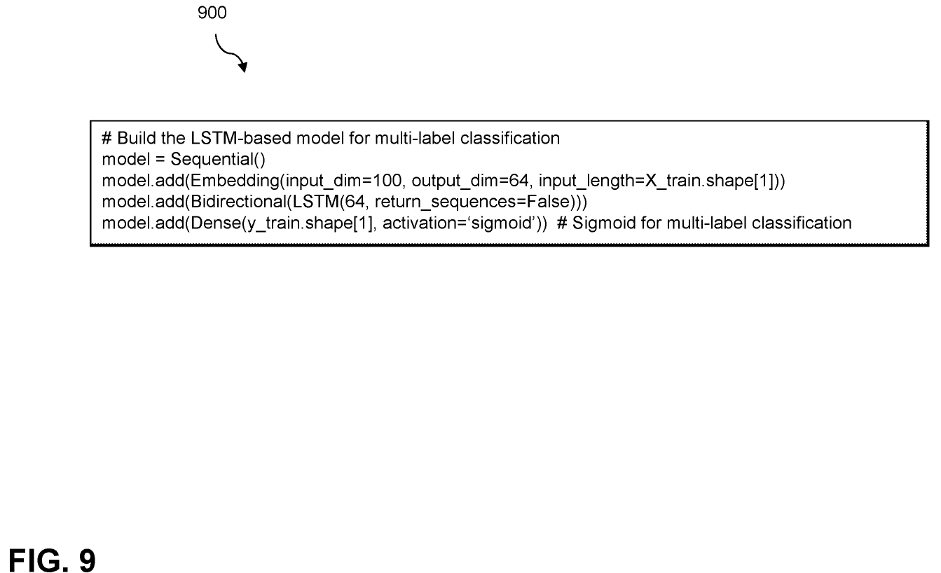

FIG. 9 shows example pseudocode for configuring a neural network model for multi-label classification in an illustrative embodiment. In this embodiment, example pseudocode 900 is executed by or under the control of at least one processing system and/or device. For example, the example pseudocode 900 may be viewed as comprising a portion of a software implementation of at least part of automated action-related data extraction and execution system 105 of the FIG. 1 embodiment.

The example pseudocode 900 illustrates creating a multi-layer, multi-label classification-capable dense LSTM-based neural network using a Keras library. More particularly, the neural network can be built using a Keras sequential function, wherein the LSTM network includes an embedding layer that converts input feature vectors into dense embeddings, a bidirectional LSTM layer that processes sequences in both directions for better context understanding, and a dense layer with a sigmoid activation function that outputs probabilities for each action item label.

It is to be appreciated that this particular example pseudocode shows just one example implementation of configuring a neural network model for multi-label classification, and alternative implementations can be used in other embodiments.

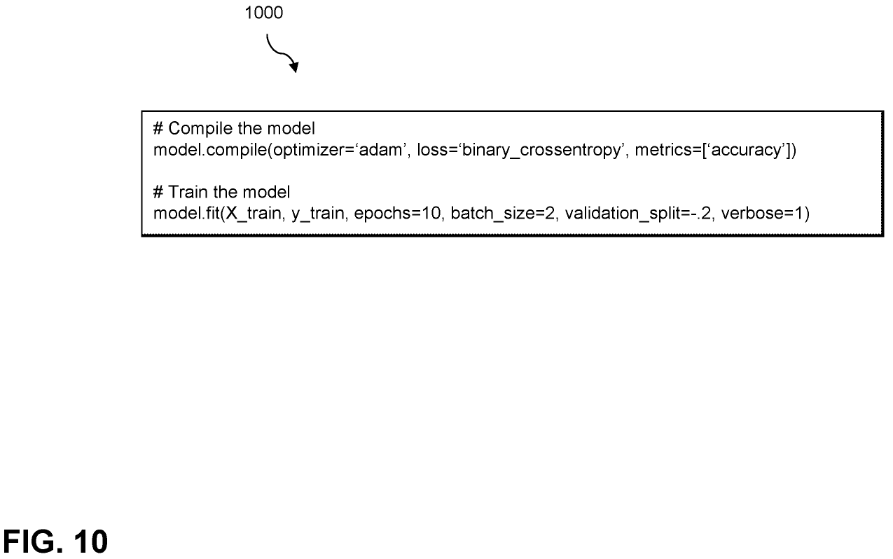

FIG. 10 shows example pseudocode for compiling and training the neural network model in an illustrative embodiment. In this embodiment, example pseudocode 1000 is executed by or under the control of at least one processing system and/or device. For example, the example pseudocode 1000 may be viewed as comprising a portion of a software implementation of at least part of automated action-related data extraction and execution system 105 of the FIG. 1 embodiment.

The example pseudocode 1000 illustrates using adaptive moment estimation (Adam) as the optimizer, “binary_cross_entropy” as the loss function, and “accuracy” as the metric for validating the model. Also, the neural network model is trained using independent variables training data (X_train) and target variable training data (y_train).

It is to be appreciated that this particular example pseudocode shows just one example implementation of compiling and training the neural network model, and alternative implementations can be used in other embodiments.

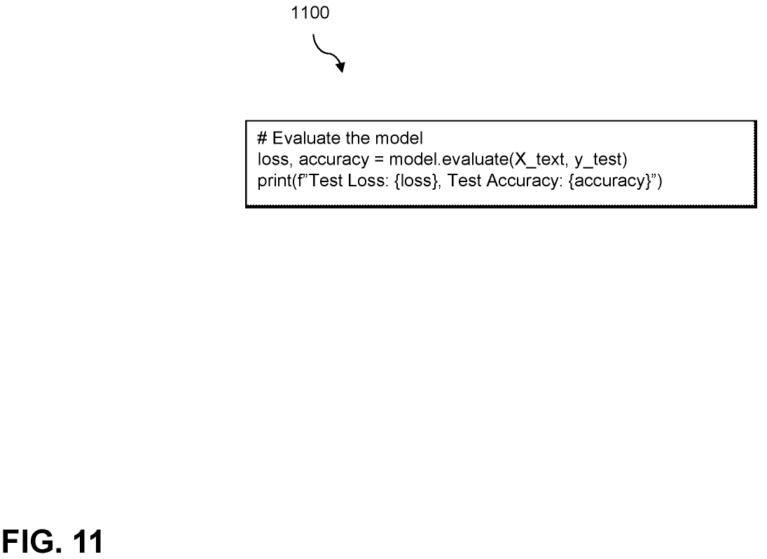

FIG. 11 shows example pseudocode for evaluating the neural network model in an illustrative embodiment. In this embodiment, example pseudocode 1100 is executed by or under the control of at least one processing system and/or device. For example, the example pseudocode 1100 may be viewed as comprising a portion of a software implementation of at least part of automated action-related data extraction and execution system 105 of the FIG. 1 embodiment.

The example pseudocode 1100 illustrates measuring the loss and accuracy of the neural network model as part of the evaluation process.

It is to be appreciated that this particular example pseudocode shows just one example implementation of evaluating the neural network model, and alternative implementations can be used in other embodiments.

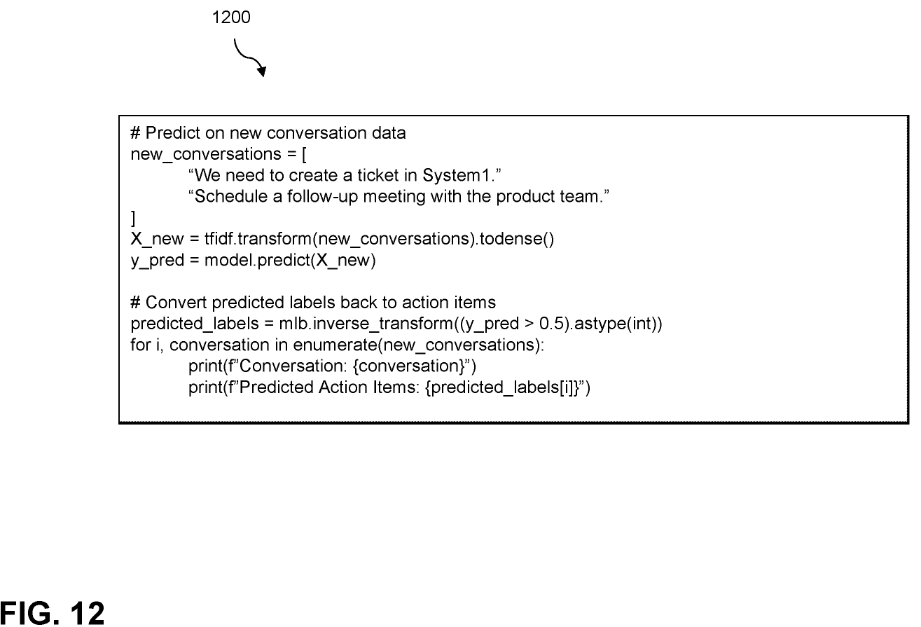

FIG. 12 shows example pseudocode for generating predictions on input conversation data in an illustrative embodiment. In this embodiment, example pseudocode 1200 is executed by or under the control of at least one processing system and/or device. For example, the example pseudocode 1200 may be viewed as comprising a portion of a software implementation of at least part of automated action-related data extraction and execution system 105 of the FIG. 1 embodiment.

The example pseudocode 1200 illustrates asking the trained neural network model to predict both target values by passing independent variable values to the predict() function of the model. Example pseudocode 1200 also illustrates converting predicted labels back to action items.

It is to be appreciated that this particular example pseudocode shows just one example implementation of generating predictions on input conversation data, and alternative implementations can be used in other embodiments.

Referring again to FIG. 3, and as further detailed herein, one or more embodiments include implementing at least one plugin prediction engine.

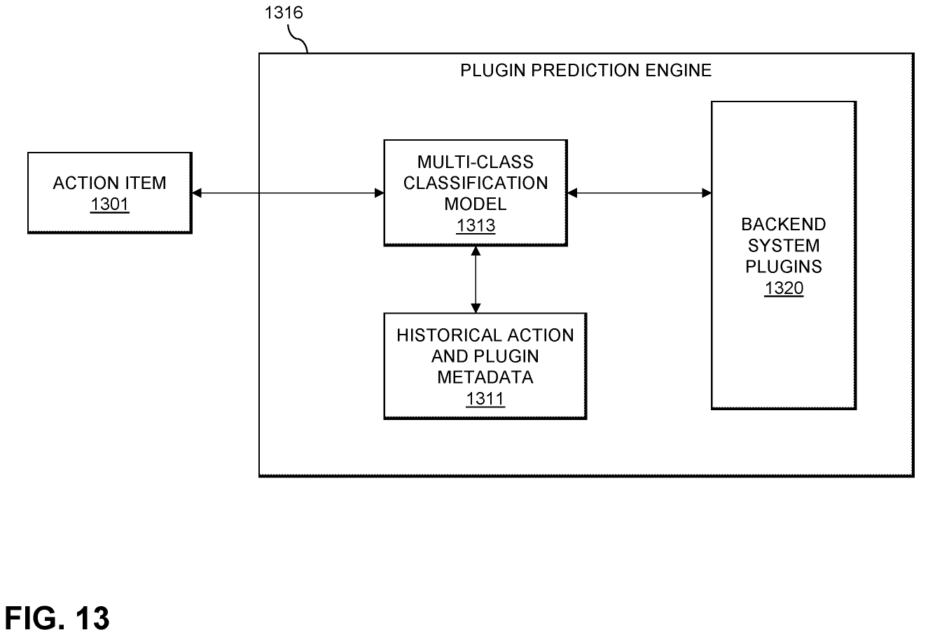

FIG. 13 shows example plugin prediction engine architecture in an illustrative embodiment. By way of illustration, FIG. 13 depicts example system architecture for plugin prediction engine 1316, which can be used to predict one or more appropriate backend system plugins 1320 for a given action item 1301 based at least in part on the particular action item 1301 and contextual data related thereto. In at least one embodiment, a plugin prediction engine 1316 includes a multi-class classification model 1313, trained on historical action and plugin metadata 1311 (e.g., as derived from one or more action and plugin metadata data structures), that predicts the appropriate plugin for executing an action item based at least in part on the action item 1301 and one or more contextual features related thereto. The context can include, for example, information such as the source of the request (e.g., internal or external), the domain (e.g., support or sales), and user roles (e.g., customer, employee, etc.). This setup allows the system to dynamically route action items and/or instructions related to execution thereof to one or more appropriate backend systems by predicting one or more suitable plugins using multi-class classification model 1313, which can include at least one deep neural network (e.g., an artificial neural network (ANN)). Such a neural network can learn from and/or be trained on historical data (e.g., historical action and plugin metadata 1311) to identify one or more patterns between action items, context, and their corresponding plugins, ensuring accuracy and scalability in real-time decision-making.

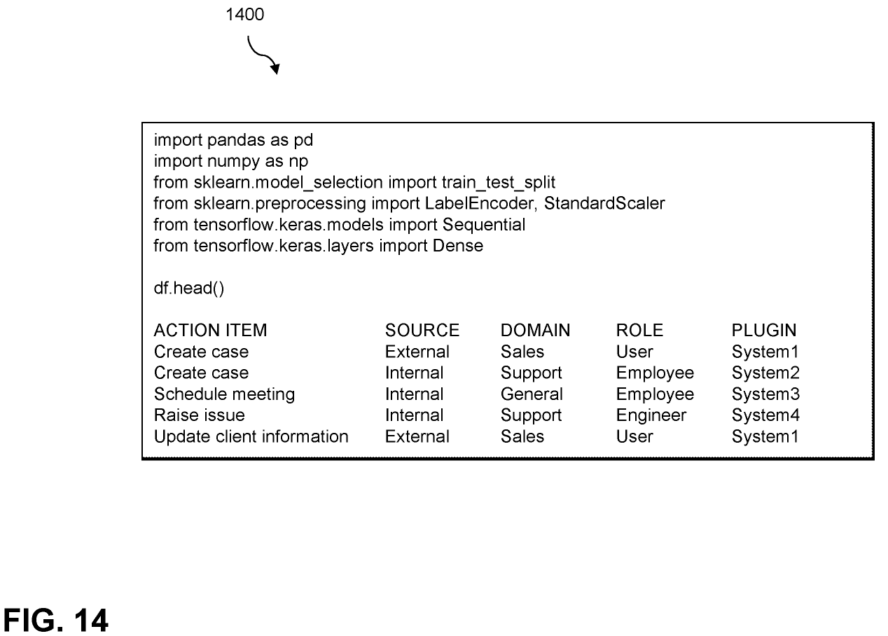

The implementation of the plugin prediction engine can be achieved at least in part, for example, as implemented in the pseudocode depicted in FIGS. 14-21, using Keras with a Tensorflow backend, Python language, as well as Pandas, Numpy and ScikitLearn libraries.

FIG. 14 shows example pseudocode for importing necessary libraries and reading metadata into a data frame in an illustrative embodiment. In this embodiment, example pseudocode 1400 is executed by or under the control of at least one processing system and/or device. For example, the example pseudocode 1400 may be viewed as comprising a portion of a software implementation of at least part of automated action-related data extraction and execution system 105 of the FIG. 1 embodiment.

The example pseudocode 1400 illustrates importing the necessary libraries and reading the relevant action and plugin metadata file into a data frame.

It is to be appreciated that this particular example pseudocode shows just one example implementation of importing necessary libraries and reading metadata into a data frame, and alternative implementations can be used in other embodiments.

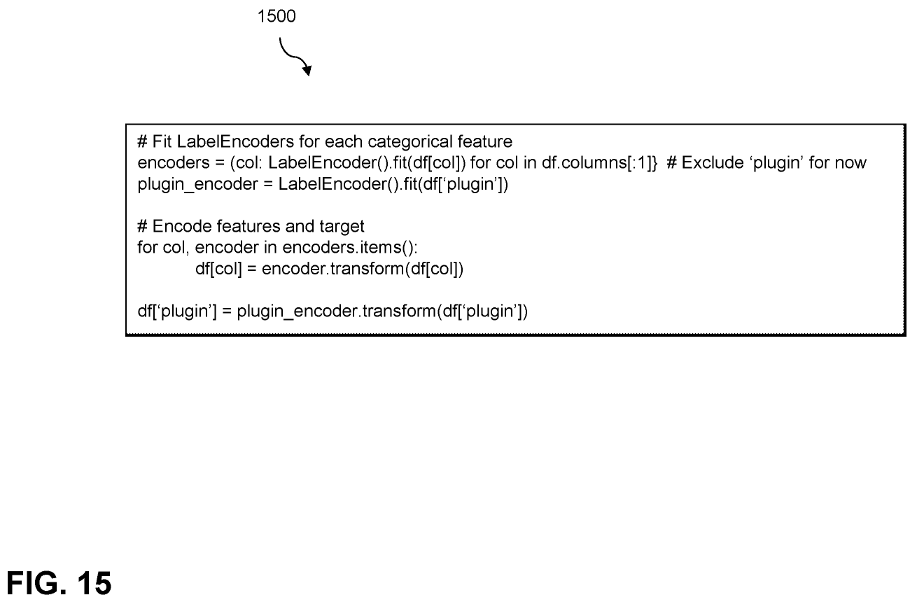

FIG. 15 shows example pseudocode for converting categorical data into numerical data in an illustrative embodiment. In this embodiment, example pseudocode 1500 is executed by or under the control of at least one processing system and/or device. For example, the example pseudocode 1500 may be viewed as comprising a portion of a software implementation of at least part of automated action-related data extraction and execution system 105 of the FIG. 1 embodiment.

The example pseudocode 1500 illustrates using label encoders to convert categorical data into numerical form, as well as encoding feature data and target data.

It is to be appreciated that this particular example pseudocode shows just one example implementation of converting categorical data into numerical data, and alternative implementations can be used in other embodiments.

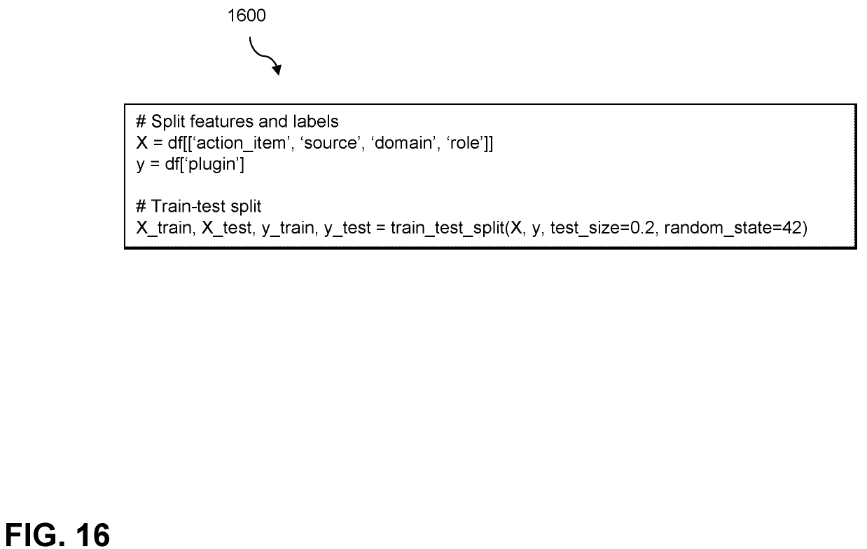

FIG. 16 shows example pseudocode for splitting feature data and target data in an illustrative embodiment. In this embodiment, example pseudocode 1600 is executed by or under the control of at least one processing system and/or device. For example, the example pseudocode 1600 may be viewed as comprising a portion of a software implementation of at least part of automated action-related data extraction and execution system 105 of the FIG. 1 embodiment.

The example pseudocode 1600 illustrates separating feature data and target (e.g., plugin) data, and splitting the dataset into training and testing sets.

It is to be appreciated that this particular example pseudocode shows just one example implementation of splitting feature data and target data, and alternative implementations can be used in other embodiments.

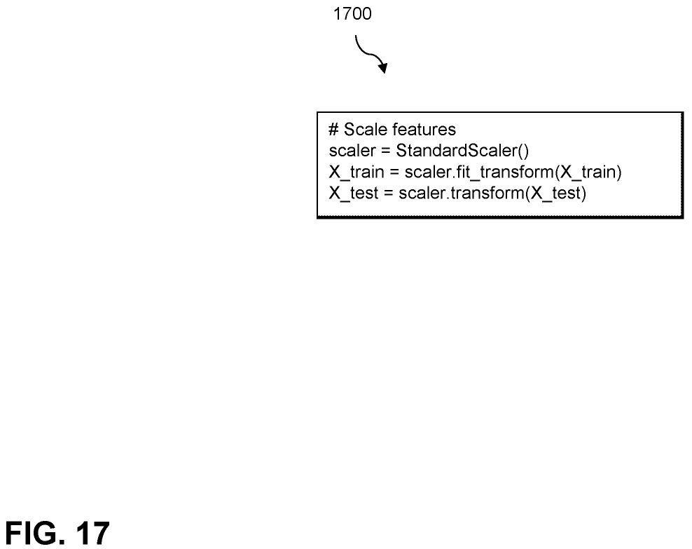

FIG. 17 shows example pseudocode for scaling feature data in an illustrative embodiment. In this embodiment, example pseudocode 1700 is executed by or under the control of at least one processing system and/or device. For example, the example pseudocode 1700 may be viewed as comprising a portion of a software implementation of at least part of automated action-related data extraction and execution system 105 of the FIG. 1 embodiment.

The example pseudocode 1700 illustrates scaling the feature data for use in connection with a neural network model, wherein such scaling is carried out using a StandardScaler function of ScikitLearn.

It is to be appreciated that this particular example pseudocode shows just one example implementation of scaling feature data, and alternative implementations can be used in other embodiments.

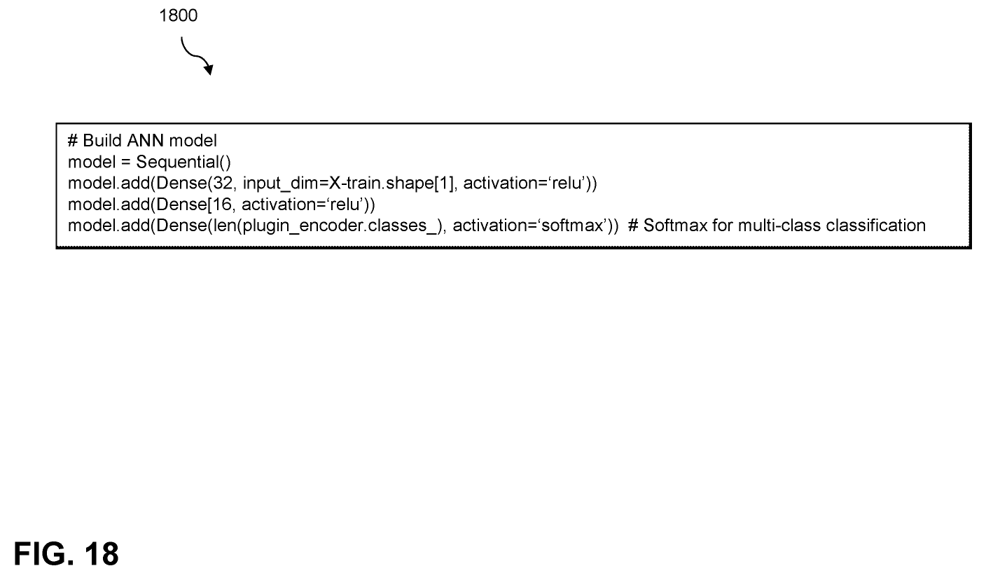

FIG. 18 shows example pseudocode for configuring a neural network model for predicting plugins in an illustrative embodiment. In this embodiment, example pseudocode 1800 is executed by or under the control of at least one processing system and/or device. For example, the example pseudocode 1800 may be viewed as comprising a portion of a software implementation of at least part of automated action-related data extraction and execution system 105 of the FIG. 1 embodiment.

The example pseudocode 1800 illustrates building a multi-layer deep neural network model with a 32 neuron-based input layer and a 16 neuron-based hidden layer, wherein such neuron amounts can be adjusted to optimize model accuracy. Also, the output layer depends upon the number of classes of target (e.g., the number of backend system plugins).

It is to be appreciated that this particular example pseudocode shows just one example implementation of configuring a neural network model for predicting plugins, and alternative implementations can be used in other embodiments.

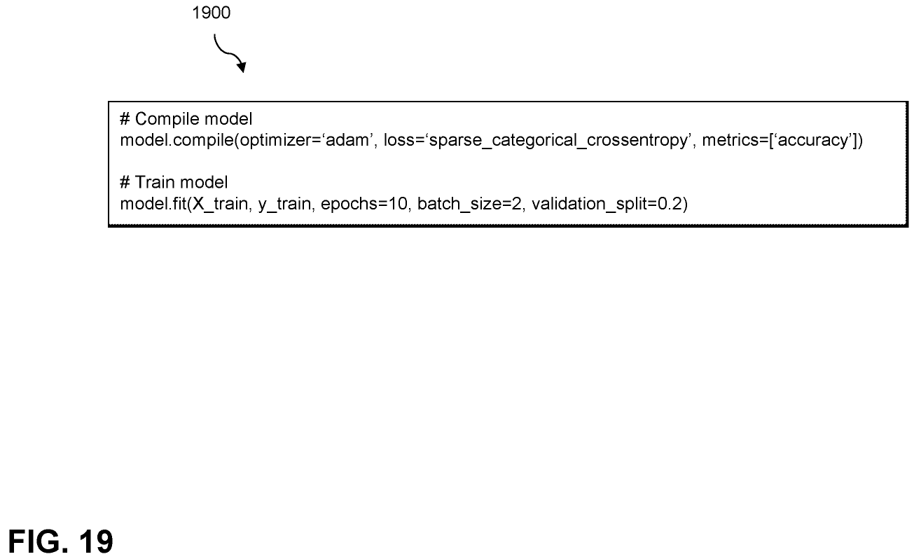

FIG. 19 shows example pseudocode for compiling and training the neural network model in an illustrative embodiment. In this embodiment, example pseudocode 1900 is executed by or under the control of at least one processing system and/or device. For example, the example pseudocode 1900 may be viewed as comprising a portion of a software implementation of at least part of automated action-related data extraction and execution system 105 of the FIG. 1 embodiment.

The example pseudocode 1900 illustrates using Adam as the optimizer, “sparse_categorical_crossentropy” as the loss function, and “accuracy” as the metric for validating the model. Also, the model is trained with independent variable training data (X_train) and target variable training data (y_train).

It is to be appreciated that this particular example pseudocode shows just one example implementation of compiling and training the neural network model, and alternative implementations can be used in other embodiments.

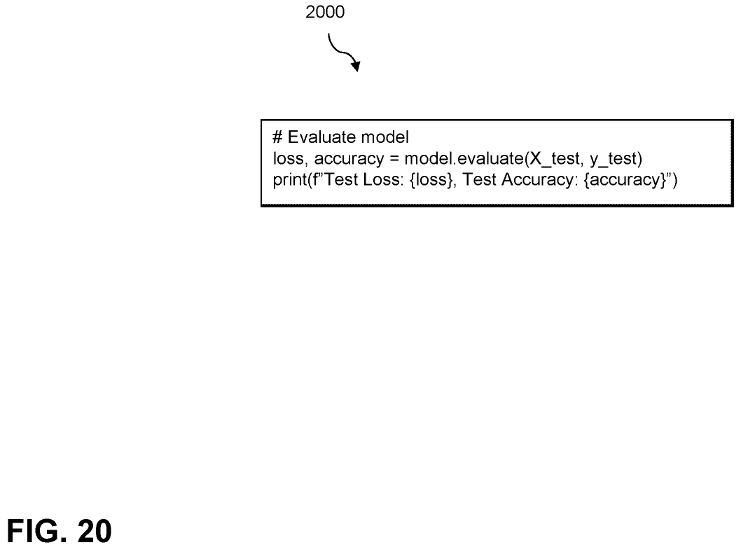

FIG. 20 shows example pseudocode for evaluating the neural network model in an illustrative embodiment. In this embodiment, example pseudocode 2000 is executed by or under the control of at least one processing system and/or device. For example, the example pseudocode 2000 may be viewed as comprising a portion of a software implementation of at least part of automated action-related data extraction and execution system 105 of the FIG. 1 embodiment.

The example pseudocode 2000 illustrates evaluating the neural network model and printing the accuracy results.

It is to be appreciated that this particular example pseudocode shows just one example implementation of evaluating the neural network model, and alternative implementations can be used in other embodiments.

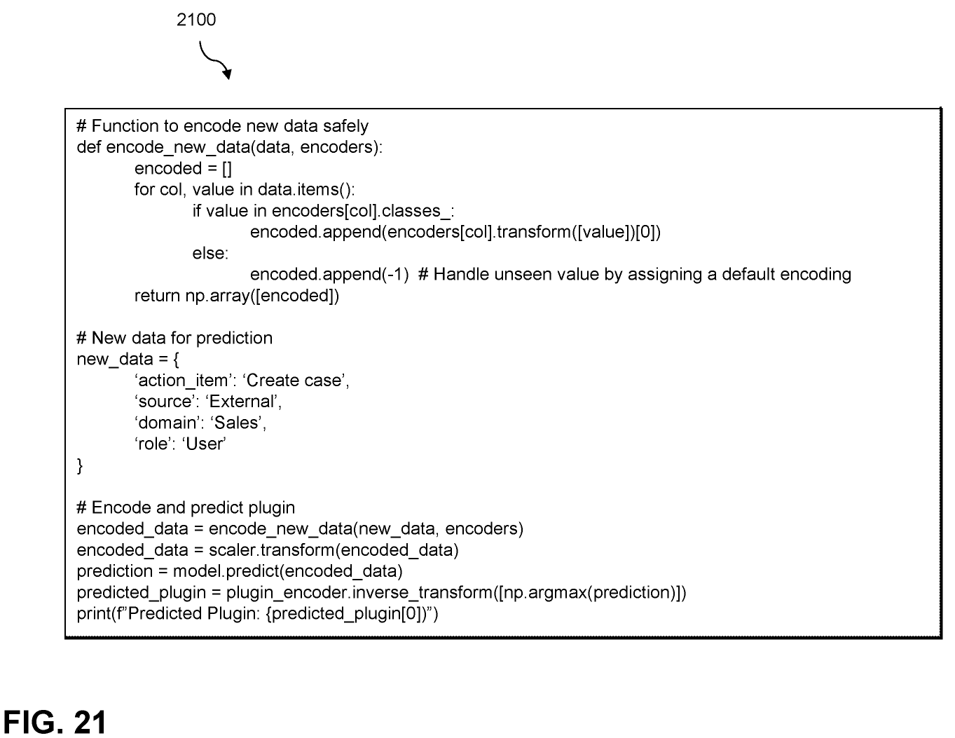

FIG. 21 shows example pseudocode for encoding input data for use in predicting a plugin in an illustrative embodiment. In this embodiment, example pseudocode 2100 is executed by or under the control of at least one processing system and/or device. For example, the example pseudocode 2100 may be viewed as comprising a portion of a software implementation of at least part of automated action-related data extraction and execution system 105 of the FIG. 1 embodiment.

The example pseudocode 2100 illustrates creating a sample action and passing the sample action to the neural network model, which then generates a backend system plugin prediction based thereon.

It is to be appreciated that this particular example pseudocode shows just one example implementation of encoding input data for use in predicting a plugin, and alternative implementations can be used in other embodiments.

Referring again to FIG. 3, and as further detailed herein, one or more embodiments include implementing one or more backend system plugins. More particularly, a backend system plugin represents a software extension, specific to a particular backend system, that is pluggable and can be added to and/or deleted from the framework detailed herein as new action items are added and/or previous or existing action items are removed. As also noted herein, smart plugins can leverage a hybrid approach for payload generation which offers a flexible mechanism to integrate with various backend systems. For example, for simple, static payloads, a smart plugin can use one or more predefined templates to ensure consistency and efficient execution. When dealing with more complex and/or dynamic scenarios, a smart plugin can utilize one or more generative artificial intelligence models with RAG techniques, enabling the dynamic construction of payloads by retrieving relevant context (e.g., user inputs, historical data, configuration settings, etc.).

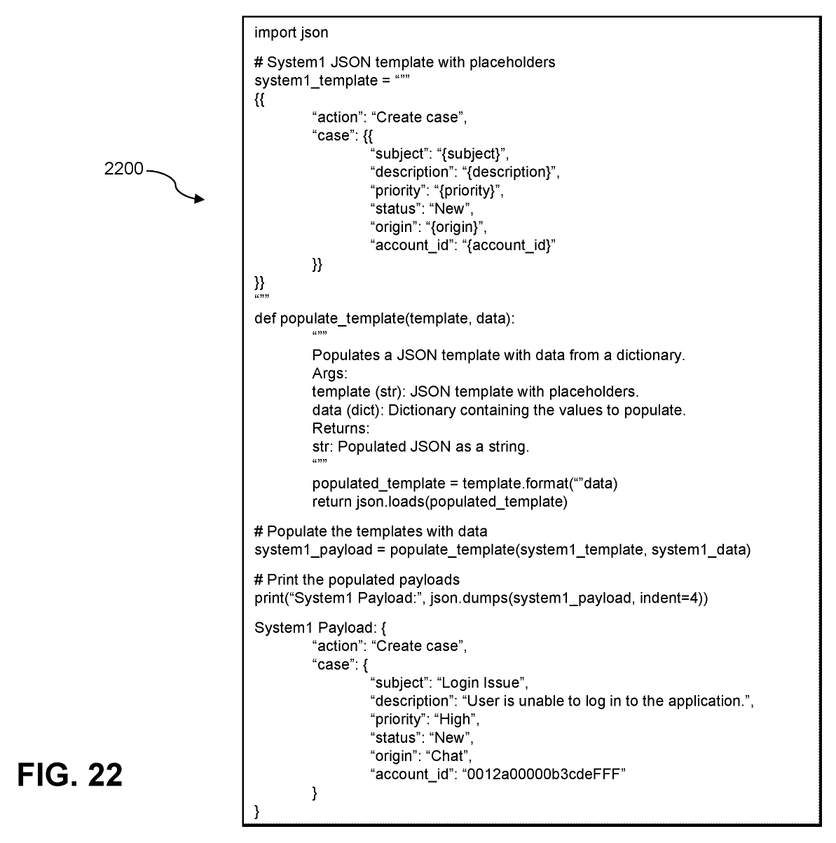

FIG. 22 shows example pseudocode for populating a payload template in an illustrative embodiment. In this embodiment, example pseudocode 2200 is executed by or under the control of at least one processing system and/or device. For example, the example pseudocode 2200 may be viewed as comprising a portion of a software implementation of at least part of automated action-related data extraction and execution system 105 of the FIG. 1 embodiment.

The example pseudocode 2200 illustrates populating a static action-related template with actual input data. As an example, for integrating with a user management enterprise use case, a JavaScript object notation (JSON) template can be used. For integrating with particular templates (e.g., a more complex template), a payload is needed. Such an embodiment can include using generative artificial intelligence in connection with retrieval-augmented generation (RAG) to dynamically create a payload by extracting context from conversation data.

It is to be appreciated that this particular example pseudocode shows just one example implementation of populating a payload template, and alternative implementations can be used in other embodiments.

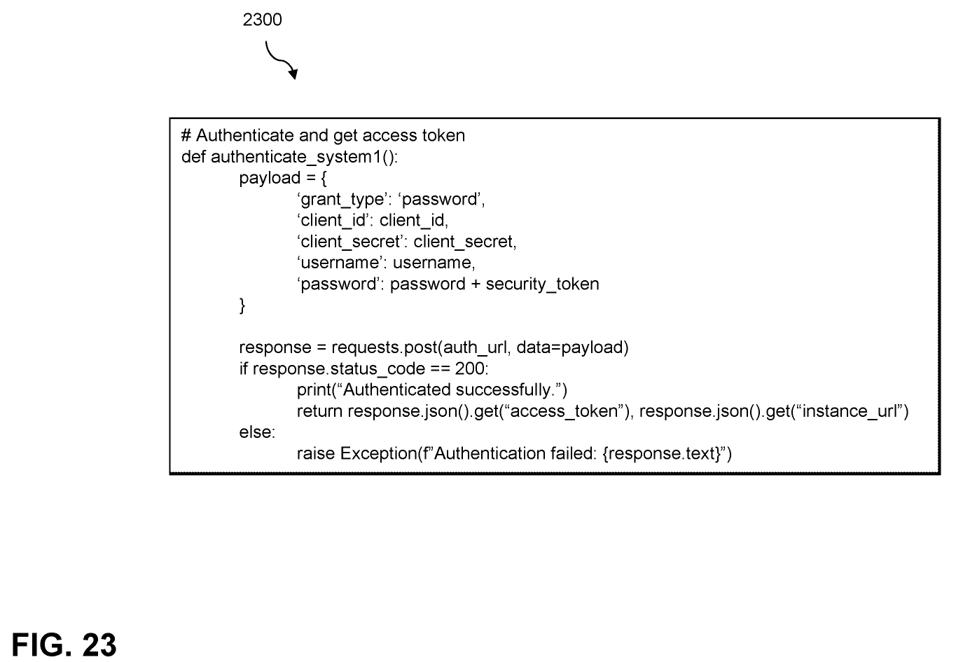

FIG. 23 shows example pseudocode for authenticating to a backend system in an illustrative embodiment. In this embodiment, example pseudocode 2300 is executed by or under the control of at least one processing system and/or device. For example, the example pseudocode 2300 may be viewed as comprising a portion of a software implementation of at least part of automated action-related data extraction and execution system 105 of the FIG. 1 embodiment.

The example pseudocode 2300 illustrates calling a create case API to facilitate authenticating to the corresponding backend system by utilizing a client identifier (ID), secret, username and password.

It is to be appreciated that this particular example pseudocode shows just one example implementation of authenticating to a backend system, and alternative implementations can be used in other embodiments.

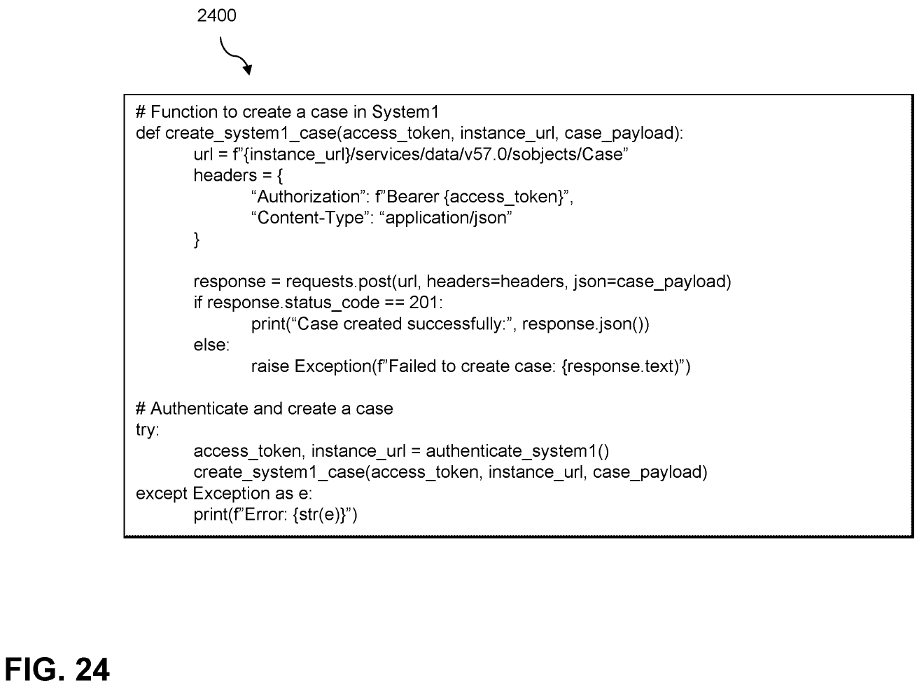

FIG. 24 shows example pseudocode for calling a function on the backend system in an illustrative embodiment. In this embodiment, example pseudocode 2400 is executed by or under the control of at least one processing system and/or device. For example, the example pseudocode 2400 may be viewed as comprising a portion of a software implementation of at least part of automated action-related data extraction and execution system 105 of the FIG. 1 embodiment.

The example pseudocode 2400 illustrates calling the function to create a case on the backend system using the proper access token and payload.

It is to be appreciated that this particular example pseudocode shows just one example implementation of calling a function on the backend system, and alternative implementations can be used in other embodiments.

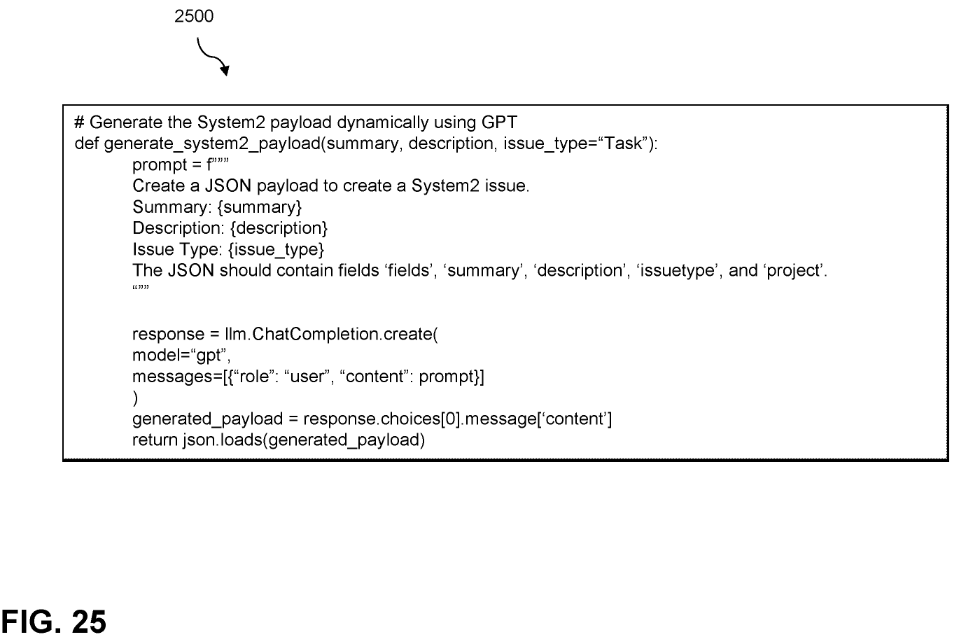

FIG. 25 shows example pseudocode for dynamically generating a payload in an illustrative embodiment. In this embodiment, example pseudocode 2500 is executed by or under the control of at least one processing system and/or device. For example, the example pseudocode 2500 may be viewed as comprising a portion of a software implementation of at least part of automated action-related data extraction and execution system 105 of the FIG. 1 embodiment.

The example pseudocode 2500 illustrates generating an issue tracking payload using generative artificial intelligence, which can enable the generation of more complex and dynamic payloads, if needed. Any prompt and data can be passed to at least one large language model (LLM) to generate the payload as shown example pseudocode 2500.

It is to be appreciated that this particular example pseudocode shows just one example implementation of dynamically generating a payload, and alternative implementations can be used in other embodiments.

By way merely of example and illustration, consider a use case involving software development project management, wherein an objective (determined by processing conversation data across relevant participants) includes implementing a system wherein an initial task, once completed, triggers additional related tasks using one or more LLMs. These follow-up actions might include, for example, quality checks, notifications to stakeholders, or related sub-tasks that depend on the completion of the first task. For example, the initial task can include fixing a bug in a login module, and once the bug is fixed, the system should automatically trigger the following actions: Assign a senior developer to review the bug fix; create a task for a team to perform testing on the login module; send an email to project stakeholders informing them that the bug has been fixed and is under review; and assign a technical writer to update the documentation if the fix requires changes to user-facing materials.

FIG. 26 is a flow diagram of a process for generating action models using generative artificial intelligence in an illustrative embodiment. It is to be understood that this particular process is only an example, and additional or alternative processes can be carried out in other embodiments.

In this embodiment, the process includes steps 2600 through 2608. These steps are assumed to be performed by the automated action-related data extraction and execution system 105 utilizing elements 112, 114, 116, 118 and 120.

Step 2600 includes obtaining conversation data from one or more communication channels. In at least one embodiment, obtaining conversation data includes obtaining conversation data derived from at least one of one or more telecommunications data sources, one or more chat data sources, one or more email data sources, and one or more information technology support data sources.

Step 2602 includes identifying one or more action items, related to at least one designated context, within the conversation data by processing at least a portion of the conversation data using a first set of one or more artificial intelligence techniques. In one or more embodiments, identifying one or more action items includes processing the at least a portion of the conversation data using at least one TF-IDF vectorizer in conjunction with at least one LSTM network model. Additionally or alternatively, identifying one or more action items can include identifying the one or more action items and classifying at least one action type associated with each of the one or more identified action items using one or more LLMs (e.g., at least one generative pretrained transformer).

Step 2604 includes determining at least one backend system plugin to be used in connection with executing at least one of the one or more action items using a second set of one or more artificial intelligence techniques. In at least one embodiment, determining at least one backend system plugin to be used includes processing data pertaining to the one or more action items using one or more NLP techniques in conjunction with at least one artificial neural network-based multi-class classifier. Additionally or alternatively, determining at least one backend system plugin to be used can include processing, using at least one LLM, at least a portion of the conversation data associated with the one or more action items, contextual data related to the one or more action items, and data pertaining to one or more capabilities of each of a set of backend systems having available plugins.

Step 2606 includes generating at least one payload for the at least one backend system plugin by processing, using generative artificial intelligence techniques, data pertaining to the at least one action item and data pertaining to the at least one backend system plugin. In one or more embodiments, generating at least one payload for the at least one backend system plugin includes processing, using generative artificial intelligence techniques with RAG, data pertaining to the at least one action item and data pertaining to the at least one backend system plugin. Additionally or alternatively, generating at least one payload for the at least one backend system plugin can further include passing the at least one generated payload to at least one API associated with the at least one corresponding backend system.

Step 2608 includes automatically executing, via at least one backend system corresponding to the at least one backend system plugin, the at least one action item using the at least one generated payload. In at least one embodiment, automatically executing the at least one action item includes utilizing at least one API associated with the at least one backend system corresponding to the at least one backend system plugin.

In one or more embodiments, the techniques depicted in FIG. 26 can also include automatically training, based at least in part on feedback pertaining to automatically executing the at least one action item, at least a portion of one or more of the first set of one or more artificial intelligence techniques, the second set of one or more artificial intelligence techniques, and the generative artificial intelligence techniques.

Accordingly, the particular processing operations and other functionality described in conjunction with the flow diagram of FIG. 26 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to automatically extract action items from conversation data and execute the action items through determined backend system plugins. These and other embodiments can effectively overcome problems associated with latencies and under-inclusive outcomes arising from resource-intensive and error-prone techniques.

It is to be appreciated that the particular advantages described above and elsewhere herein are associated with particular illustrative embodiments and need not be present in other embodiments. Also, the particular types of information processing system features and functionality as illustrated in the drawings and described above are examples only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

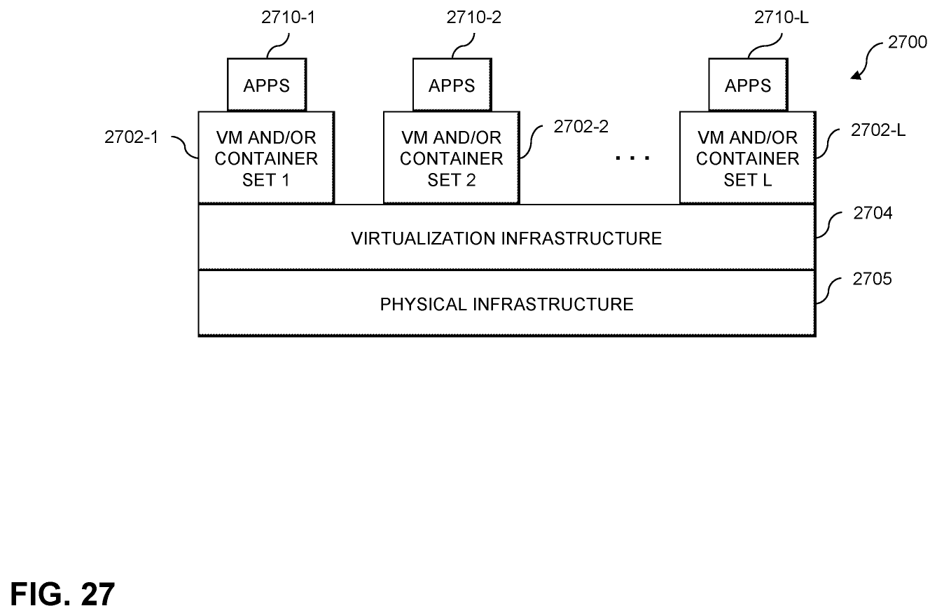

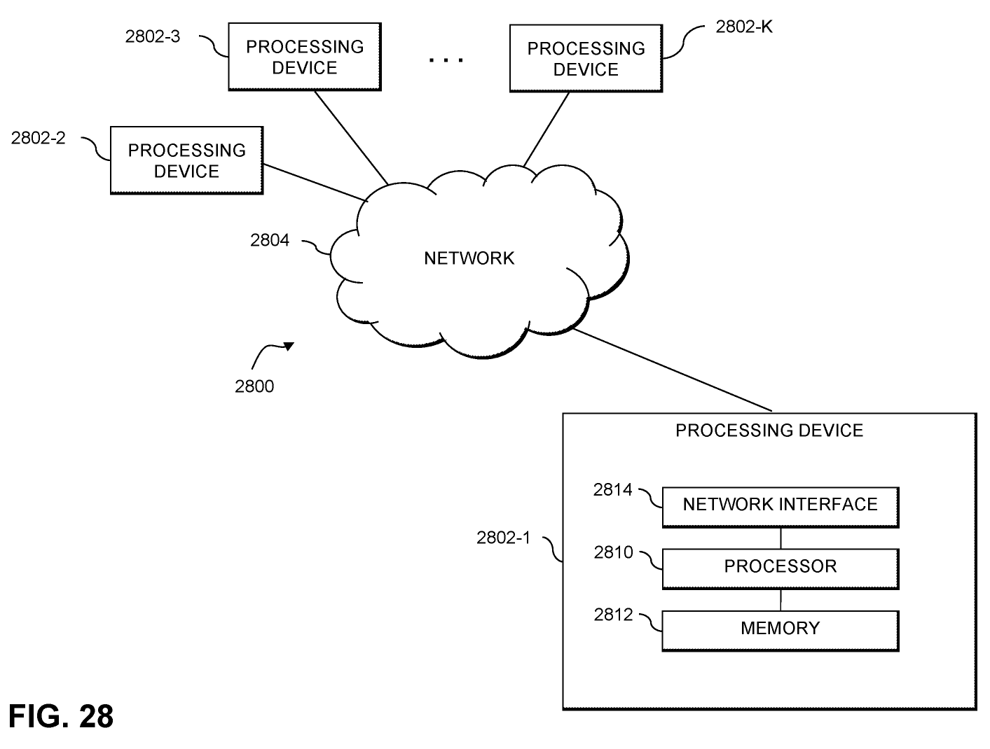

Illustrative embodiments of processing platforms will now be described in greater detail with reference to FIGS. 27 and 28. Although described in the context of system 100, these platforms may also be used to implement at least portions of other information processing systems in other embodiments.

FIG. 27 shows an example processing platform comprising cloud infrastructure 2700. The cloud infrastructure 2700 comprises a combination of physical and virtual processing resources that are utilized to implement at least a portion of the information processing system 100. The cloud infrastructure 2700 comprises multiple virtual machines (VMs) and/or container sets 2702-1, 2702-2, . . . 2702-L implemented using virtualization infrastructure 2704. The virtualization infrastructure 2704 runs on physical infrastructure 2705, and illustratively comprises one or more hypervisors and/or operating system level virtualization infrastructure. The operating system level virtualization infrastructure illustratively comprises kernel control groups of a Linux operating system or other type of operating system.

The cloud infrastructure 2700 further comprises sets of applications 2710-1, 2710-2, . . . 2710-L running on respective ones of the VMs/container sets 2702-1, 2702-2, . . . 2702-L under the control of the virtualization infrastructure 2704. The VMs/container sets 2702 comprise respective VMs, respective sets of one or more containers, or respective sets of one or more containers running in VMs. In some implementations of the FIG. 27 embodiment, the VMs/container sets 2702 comprise respective VMs implemented using virtualization infrastructure 2704 that comprises at least one hypervisor.

A hypervisor platform may be used to implement a hypervisor within the virtualization infrastructure 2704, wherein the hypervisor platform has an associated virtual infrastructure management system. The underlying physical machines comprise one or more information processing platforms that include one or more storage systems.

In other implementations of the FIG. 27 embodiment, the VMs/container sets 2702 comprise respective containers implemented using virtualization infrastructure 2704 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 2700 shown in FIG. 27 may represent at least a portion of one processing platform. Another example of such a processing platform is processing platform 2800 shown in FIG. 28.

The processing platform 2800 in this embodiment comprises a portion of system 100 and includes a plurality of processing devices, denoted 2802-1, 2802-2, 2802-3, . . . 2802-K, which communicate with one another over a network 2804.

The network 2804 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 2802-1 in the processing platform 2800 comprises a processor 2810 coupled to a memory 2812.

The processor 2810 comprises a microprocessor, an ASIC, an SOC, an FPGA, a CPU, a GPU, an NPU, a DPU, a TPU, an ALU, a DSP, and/or other similar processing device components, as well as other types and arrangements of processing circuitry, in any combination. At least a portion of the functionality of at least one artificial intelligence system and its associated artificial intelligence algorithms provided by one or more processing devices as disclosed herein can be implemented using such circuitry.

The memory 2812 comprises RAM, ROM or other types of memory, in any combination. The memory 2812 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 2802-1 is network interface circuitry 2814, which is used to interface the processing device with the network 2804 and other system components, and may comprise conventional transceivers.

The other processing devices 2802 of the processing platform 2800 are assumed to be configured in a manner similar to that shown for processing device 2802-1 in the figure.

Again, the particular processing platform 2800 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as examples rather than as requirements or limitations of the disclosure. Numerous other alternative embodiments within the scope of the appended claims will be readily apparent to those skilled in the art.

What is claimed is:

1. A computer-implemented method comprising:
obtaining conversation data from one or more communication channels;
identifying one or more action items, related to at least one designated context, within the conversation data by processing at least a portion of the conversation data using a first set of one or more artificial intelligence techniques;
determining at least one backend system plugin to be used in connection with executing at least one of the one or more action items using a second set of one or more artificial intelligence techniques;
generating at least one payload for the at least one backend system plugin by processing, using generative artificial intelligence techniques, data pertaining to the at least one action item and data pertaining to the at least one backend system plugin; and
automatically executing, via at least one backend system corresponding to the at least one backend system plugin, the at least one action item using the at least one generated payload;
wherein the method is performed by at least one processing device comprising a processor coupled to a memory.

2. The computer-implemented method of claim 1, wherein identifying one or more action items comprises processing the at least a portion of the conversation data using at least one term frequency-inverse document frequency (TF-IDF) vectorizer in conjunction with at least one long short-term memory (LSTM) network model.

3. The computer-implemented method of claim 1, wherein determining at least one backend system plugin to be used comprises processing data pertaining to the one or more action items using one or more natural language processing (NLP) techniques in conjunction with at least one artificial neural network-based multi-class classifier.

4. The computer-implemented method of claim 1, wherein generating at least one payload for the at least one backend system plugin comprises processing, using generative artificial intelligence techniques with retrieval augmented generation (RAG), data pertaining to the at least one action item and data pertaining to the at least one backend system plugin.

5. The computer-implemented method of claim 1, wherein automatically executing the at least one action item comprises utilizing at least one application programming interface (API) associated with the at least one backend system corresponding to the at least one backend system plugin.

6. The computer-implemented method of claim 1, wherein identifying one or more action items comprises identifying the one or more action items and classifying at least one action type associated with each of the one or more identified action items using one or more large language models (LLMs).

7. The computer-implemented method of claim 1, wherein determining at least one backend system plugin to be used comprises processing, using at least one LLM, at least a portion of the conversation data associated with the one or more action items, contextual data related to the one or more action items, and data pertaining to one or more capabilities of each of a set of backend systems having available plugins.

8. The computer-implemented method of claim 1, wherein generating at least one payload for the at least one backend system plugin further comprises passing the at least one generated payload to at least one API associated with the at least one corresponding backend system.

9. The computer-implemented method of claim 1, further comprising:
automatically training, based at least in part on feedback pertaining to automatically executing the at least one action item, at least a portion of one or more of the first set of one or more artificial intelligence techniques, the second set of one or more artificial intelligence techniques, and the generative artificial intelligence techniques.

10. The computer-implemented method of claim 1, wherein obtaining conversation data comprises obtaining conversation data derived from at least one of one or more telecommunications data sources, one or more chat data sources, one or more email data sources, and one or more information technology support data sources.

11. A non-transitory processor-readable storage medium having stored therein program code of one or more software programs, wherein the program code when executed by at least one processing device causes the at least one processing device:
to obtain conversation data from one or more communication channels;
to identify one or more action items, related to at least one designated context, within the conversation data by processing at least a portion of the conversation data using a first set of one or more artificial intelligence techniques;
to determine at least one backend system plugin to be used in connection with executing at least one of the one or more action items using a second set of one or more artificial intelligence techniques;
to generate at least one payload for the at least one backend system plugin by processing, using generative artificial intelligence techniques, data pertaining to the at least one action item and data pertaining to the at least one backend system plugin; and
to automatically execute, via at least one backend system corresponding to the at least one backend system plugin, the at least one action item using the at least one generated payload.

12. The non-transitory processor-readable storage medium of claim 11, wherein identifying one or more action items comprises processing the at least a portion of the conversation data using at least one term frequency-inverse document frequency (TF-IDF) vectorizer in conjunction with at least one long short-term memory (LSTM) network model.

13. The non-transitory processor-readable storage medium of claim 11, wherein determining at least one backend system plugin to be used comprises processing data pertaining to the one or more action items using one or more natural language processing (NLP) techniques in conjunction with at least one artificial neural network-based multi-class classifier.

14. The non-transitory processor-readable storage medium of claim 11, wherein generating at least one payload for the at least one backend system plugin comprises processing, using generative artificial intelligence techniques with retrieval augmented generation (RAG), data pertaining to the at least one action item and data pertaining to the at least one backend system plugin.

15. The non-transitory processor-readable storage medium of claim 11, wherein automatically executing the at least one action item comprises utilizing at least one application programming interface (API) associated with the at least one backend system corresponding to the at least one backend system plugin.

16. An apparatus comprising:
at least one processing device comprising a processor coupled to a memory;
the at least one processing device being configured:
to obtain conversation data from one or more communication channels;
identifying one or more action items, related to at least one designated context, within the conversation data by processing at least a portion of the conversation data using a first set of one or more artificial intelligence techniques;
to determine at least one backend system plugin to be used in connection with executing at least one of the one or more action items using a second set of one or more artificial intelligence techniques;
to generate at least one payload for the at least one backend system plugin by processing, using generative artificial intelligence techniques, data pertaining to the at least one action item and data pertaining to the at least one backend system plugin; and
to automatically execute, via at least one backend system corresponding to the at least one backend system plugin, the at least one action item using the at least one generated payload.

17. The apparatus of claim 16, wherein identifying one or more action items comprises processing the at least a portion of the conversation data using at least one term frequency-inverse document frequency (TF-IDF) vectorizer in conjunction with at least one long short-term memory (LSTM) network model.

18. The apparatus of claim 16, wherein determining at least one backend system plugin to be used comprises processing data pertaining to the one or more action items using one or more natural language processing (NLP) techniques in conjunction with at least one artificial neural network-based multi-class classifier.

19. The apparatus of claim 16, wherein generating at least one payload for the at least one backend system plugin comprises processing, using generative artificial intelligence techniques with retrieval augmented generation (RAG), data pertaining to the at least one action item and data pertaining to the at least one backend system plugin.

20. The apparatus of claim 16, wherein automatically executing the at least one action item comprises utilizing at least one application programming interface (API) associated with the at least one backend system corresponding to the at least one backend system plugin.
